(19) United States
(12) Patent Application Publication
(10) Pub. No.: US 2011/0093343 A1
(43) Pub. Date: Apr. 21, 2011

(54) System and Method of Content Generation

(75) Inventor: Hamid Hatami-Hanza, Thornhill (CA)

(73) Assignee: Hamid Hatami-Hanza, Thornhill (CA)

(21) Appl. No.: 12/908,856

(22) Filed: Oct. 20, 2010

Related U.S. Application Data
(60) Provisional application No. 61/253,511, filed on Oct. 21, 2009.

(51) Int. Cl. G06F 17/30; G06Q 30/00

(52) U.S. Cl. 705/14.64; 707/739; 707/E17.089

(57) ABSTRACT

Methods and systems are given for representing and generating contents from pre-existed and pre-built contents for a given content. Methods are given for transforming information representation from one medium, type, or language to another medium, type and language. Exemplary embodiment is given for transforming the semantics of a given text or spoken language to a visual representation or combination of them. The systems and methods generate new contents in general and multimedia contents in particular in response to or for representing an input composition utilizing pre-existed and pre-built contents of various types, languages, and forms. The associated client server systems over the communication network are also given for generating contents for the contents given by the clients.

### CROSS-REFERENCED TO RELATED APPLICATIONS

This application claims priority from U.S. provisional patent application No. 61/253,511 filed on Oct. 21, 2009, entitled “System and Method of Multimedia Generation” which is incorporated herein by reference.

### FIELD OF INVENTION

This invention generally relates to information processing, content processing and generation, multimedia, ontological subject processing, and generating multimedia compositions.

### BACKGROUND OF THE INVENTION

Content creation and generation is an important task in the online world of today for variety of reasons and in various areas of interest. The subject matters of the contents can range from sophisticated scientific research topics and programs, local or global political issues, business oriented analysis, to the daily life subject matters of temporary interest such as celebrity news, advertisement, entertainment etc. The contents are usually represented by a variety of types and media forms such as textual, audio or aural, visual, graphical, or by any combination of them, i.e. multimedia, in general.

Multimedia contents are more in demand and valuable since contents would be much more informative, entertaining, pleasing and easier to grasp when they are accompanied by more than one media representations. However, valuable content creation and particularly multimedia content creation and generation is not a trivial task.

A creator of a valuable content should usually know a great deal about the subject matter of the content and ways of presentations in order to create even a single media content such as a textual content. Making multimedia contents needs yet additional expertise, is time consuming, expensive and do not lend itself to automation easily.

Consequently, generation of content in general, and multimedia content in particular, is not straightforward making it a difficult assignment for general public as well as professional. Therefore, there is a need in the art for a process or method and system that can facilitate the production and sharing of variety of contents for everyone and for many desirable applications.

### SUMMARY OF THE INVENTION

Information and contents can be represented by different languages and forms such as text, audio, image, video or combination of these forms.

A content creator, usually, has some ideas, design, scripts, or perhaps just a keyword and would like to generate a desired content for publishing or broadcasting or presentation. The starting content can be a short message text (e.g. SMS), twitter message, an audio command or speech, an email, a movie script, a short or long essay, written or spoken in any language. The starting content can even sometimes be a multimedia content. Assuming we have a given content then the problem is to transform the given content to another content having different materials, length, languages, media form, or publication/broadcasting type. Therefore, very often or for variety of reasons we need to represent a content by another content.

Accordingly, it would be desirable to have a method and system that can transform the representation of information from one form, language, and shape to another by capturing and regenerating the essence and semantics of the given information and represent it in another form having a desired semantic relationship with the given content. For instance, text messages in the forms of short messaging services (SMS), emails, twitter texts, or even long essays and scripts, would be more appealing and sometimes more informative if they are accompanied or transformed to a visual or aural message that are semantically related to the given message. Specially for entertainment, education, artistic experimentations, advertisement, and many other desirable applications it can be quite useful to have a system with a method of converting, for instance, textual compositions to, or accompanying by, other forms such as compositions of visual, audio, graphical, or graphical essay, and the like.

In this disclosure a method and system is presented to find or generate a representative content for a given content. The representative content can be of the same or different type of content media. The method can be used to generate a textual representative content for a textual given content, a visual representative content for a given textual content or a given aural content and/or vice versa, or an audio representative content for a given visual content or given textual content and/or vice versa and so forth.

According to one embodiment of the invention the representative content is found or is composed or is generated from pre-existing or pre-built contents or the partitions of pre-exited or pre-built contents.

The problem then lies in finding or selecting an appropriate representative for a given content. The most appropriate representative content however is not always easy to find since there can be found many representative contents for a given content or sometimes not being able to find a suitable enough representative satisfying the desired semantic relationship between the given content and the representative one. The most appropriate representative content may be found in different partitions of a collection of contents that may not be of the same form and type as the given content.

The disclosed method is in effect to transform or translate the contents of different forms, types, and languages to each other in order to produce a desired content as a representative for a given content. Although the disclosed method is essentially applicable for performing content representation and transformation regardless of the type of content and languages, in the exemplified embodiment we use the method in a general instance. That is to generate multimedia content for a given content. However, since semantics can be best processed by textual representation therefore we focus on transforming the textual information to other types or converting a multimedia content to another multimedia content by extracting the textual information of the multimedia contents. Hence, in the description of we use an equally general exemplary embodiment wherein the given content is a textual content which will be transformed to or will be represented by multimedia content. In one embodiment, according to this disclosure, this is done automatically for an input content and/or and at the request of a user or a client's.

The method uses the existing or pre-built contents to generate new contents. According to one embodiment of the invention, a plurality of multimedia contents or a set of segments of multimedia contents are obtained from which the Ontological Subjects of different types, e.g. textual, audio or aural, visual, are extracted from the said plurality of multimedia contents or their partitions. Ontological subjects, used in this disclosure, in general, are in accordance with the definitions of patent application entitled “System And Method For A Unified Semantic Ranking Of Compositions Of Ontological Subjects And The Applications Thereof”. Filed on Apr. 7, 2010, application Ser. No. 12/755,415 (incorporated herein as a reference). However, more specific types of Ontological Subjects (OSs) are given in the definition section of the detailed description of the current disclosure.

The corresponded Ontological Subjects of different types then are stored and indexed in a computer readable database or storage media for further processing and usage. From the list of OSs of the different type, desired types of Participation Matrixes, having desired orders, (denoted by XYPM^{kl} in this disclosure) are built. The XYPM^{kl}s show the participation of Ontological Subjects of one type (type X) and a predetermined order (order k) into Ontological Subjects of another type (type Y) and another predetermined order (order l).

For instance a TVPM¹² can be built that shows in each partitions of a movie what words have been used in the dialogue of the characters in the movie's partitions, or segments, or clips (the T stands for textual and V stands for visual Ontological subjects). So effectively one dimension of the matrix corresponds to the words and another dimension is corresponded to the clip that the words have been appeared or used. (the clips can, for instance, be denoted by names of the data files that the clips are stored)

Depends on the application, different PM matrixes can be built to show, for instances, the participation of audio partitions in text partitions, audio partitions in visual partition, or textual partitions in textual partitions and so on. Nevertheless, since the semantically related partitions of different types can be represented and processed easier by its textual forms, we mainly focus on the participations matrices of TTPM^{kl} format.

The information of the TTPM^{kl}s are used for finding and selecting the most appropriate partitions of one type, language, and form as the representative of one or more Ontological Subjects of another type, language, and form. For instance, using the raking methods disclosed in the non-provisional patent application Ser. No. 12/755,415 which is incorporated herein as reference; one can scores all the partitions of a composition or a set of compositions that contain a specific OS or a group of specific OSs and select the most semantically related partitions based on their scores or ranks. In fact when the stored repository of pre-existing multimedia partitions becomes very large, the information of Participation Matrixes and the ranking methods of patent application Ser. No. 12/755,415 can be used to cluster and classify the partitions and/or be used for searching thorough countless multimedia pre-existing partitions and find the most semantically related multimedia partitions in response to a query and building an effective multimedia search engine.

Methods are given for calculating the most semantically related partitions from a set of partitions, e.g. existing partitions of plurality of contents, to a given partition. In one embodiment, the method comprises building participation matrix/s for a first set of contents and also building participation matrix/s for the given content and using the information of the both participation matrices to find the most semantically related partitions from the first set of content to the partitions of the given content.

Exemplary systems are also given for generating a new multimedia composition from pre-existing, or pre-built multimedia partitions for an input composition or content. In one embodiment, we desire to find the most semantically related pre-existed partitions to the partitions of an input composition to the system for which we want to compose a semantically related multimedia composition. The semantic relatedness is a predefined relationship function. For instance, a semantic relationship can be defined as “similarity” which can be measured by simply counting/calculating the common OSs of the two partitions or be measured by evaluating/calculating other predefined similarity functions. More desired or complicated relationships can also be considered, such as a certain range of semantic similarity, or semantically opposite relation, or semantic stem similarity, contextual correlations, etc.

Now, for instance, when a client or user input a message in the form of a text or audio the method provide algorithm/s to select the most appropriate visual or audio partition to represent the text or the audio for accompanying the message or be used instead of the message. The system then composes a multimedia content by retrieving the pre-stored partitions of the multimedia, from the storage, databases, or filing systems and assembles a new multimedia content according to the clients input or request essentially using the existing or pre-built contents.

The system employing the method can further expand the client's input, (i.e. the given content) to include more semantics and materials according to the definition of services that the system is designed for. In one embodiment the expansion is equivalent to applying the method more than once. For instance one can generate a secondary content for the given content and then apply the method further to generate yet another content (e.g. a multimedia) for the generated secondary content.

Furthermore, the characteristics or attributes of the audio, video or texts can be modified before composing the final generated contents using the customary methods of video and signal processing or text processing methods. For instance, a movie can be transformed to animation using video processing methods (e.g. by edge detection) or colors being modified, voice being modified by speech processing methods (e.g. synthesizing or modifying voices), voice being generated by computer, or replacing words or phrases with other words and phrases in the text by natural language processing methods (e.g. synonym substitution), etc.

Moreover the method and system can readily be used for clustering or classifying contents and/or searching and finding the most appropriate videos or multimedia contents from a collection or repository of videos and multimedia contents, in response to given content (e.g. a keyword, question, textual content, audio command, speech, another multimedia etc.)

The visual or audio partitions can be selected from a special genre, or specified character/s, player, voices, music, types and the like. Alternatively the inventory of partitions of the existing or pre-built multimedia contents can be classified under different databases according to predetermined criteria such as the genre, directors, creators, writers, speakers, or the character/s, the voice of the characters, or any other desired criteria. A non comprehensive list of applications is given in the description for illustration purposes only. Those skilled and knowledgeable in the art can readily employ or adapt the method for variety of applications that have not been explicitly mentioned throughout the disclosure without departing from the scope and sprit of the present invention.

### BRIEF DESCRIPTION OF DRAWINGS

FIG. 1a: illustrates conceptually an exemplary embodiment of a multimedia content and shows the process of a method for extracting and storing the ontological subjects of different type and order from a plurality of multimedia segments or compositions and build the participation matrices.

FIG. 1b: illustrate more explicitly the concept of participation matrix and the process of building one exemplary participation matrix for the multimedia content of FIG. 1a.

FIG. 2: illustrates one embodiment of blocks of the method for extracting and storing the ontological subjects of a plurality of multimedia compositions and building the participation matrices.

FIG. 3: illustrates more explicitly another embodiment of blocks of the method for extracting and storing the ontological subjects of a plurality of multimedia compositions and building the participation matrices.

FIG. 4: shows one exemplary embodiment of the basic blocks of the method for generating a multimedia composition based on the information of an input content.

FIG. 5a: illustrates explicitly the building of one desired participation matrix, i.e. TTPM¹² for an exemplary input content in the form of an input text.

FIG. 5b: shows the process of using the stored TTPMₛₜ¹² from the FIG. 1a, and the constructed TTPMᵢₙ¹² for the input composition from FIG. 5a, to calculate the similarity matrix and select the most semantically related partition of other OS type to be used for representing or accompany the input textual composition.

FIG. 6: shows one exemplary embodiment of a system and a service for generating multimedia composition for a client according to the client's input content and providing a distribution service and access for the creator of the composition.

FIG. 7: the system and method for user generated multimedia content that includes an option for user for advertisement revenue sharing between the service provider and the creator.

### DETAILED DESCRIPTION

Information bearing symbols can be in the form of audio signals, text characters, and visuals such as pictures, still images, animations, or video clips and signals. In this disclosure the information bearing symbols are called Ontological Subjects and are defined herein below in the definitions section.

### I—DEFINITIONS

This disclosure uses the definitions that were introduced in the U.S. patent application Ser. No. 12/755,415, which is incorporated as a reference. However more specific definitions are defined hereunder to better explain and simplify the understanding and explanation of the current disclosure.
   1. Ontological Subject: symbol or signal referring to a thing worthy of knowing about. Therefore “Ontological Subject” means generally any string of characters, but more specifically letters, numbers, words, bits, mathematical functions, sound signal tracks, video signal tracks, electrical signals, or the name of their storage places in a computer readable storage medium, such as the file name in which a video signal or data is stored. In this disclosure Ontological Subject/s and the abbreviation OS or OSs are used interchangeably.
For the purpose of explaining this description we further label the Ontological Subjects based on their type of representation as the followings:
   1) TOS: is used to denote the OSs of textual type such as alphabets and characters, computer codes, words, sentences, paragraphs, documents, or any textual composition written in any language.
   2) VOS: is used to denote the OSs of visual type, such as picture, image, still image, graphs, video or any visual compositions such as video clips etc. More specifically and in practice the VOSs are represented by the symbols or names that are referring to the stored places of such visual data.
   3) AOS: is used to denote the OSs of audio or aural type such as sound tracks, sound effects, conversation tracks, or any audio composition. More specifically and in practice the AOSs are represented by the symbols or names that are referring to the stored places of such audio data.
      Moreover, Ontological Subjects can be divided into sets with different orders depends on their length and/or syntax function. For instance, for ontological subjects of textual type, one may characterizes letters as zero order OS, words as the first order (each word can mathematically being considered as a set of letters or characters, e.g. a word is a set of zeroth order OS in this instance), sentences as the second order, paragraphs as the third order, pages or chapters as the forth order, documents as the fifth order, corpuses as the sixth order OS and so on. The order of an OS will be denoted by an upper index when naming the OS type. For example words are denoted by TOS¹ (means textual OSs of order 1), and sentences are denoted by TOS² and so on. As seen a higher order OS can be considered as a set of lower order OSs.
   2. Composition: A composition is also an Ontological Subject which can be broken to lower order constituent OSs. However here we use the word “composition” as a special case OS wherein it is an intentioned or the desired composition of other OSs. Therefore a composition is an OS, having an order and a type, which is made from combination of ontological subjects of lower or the same order, i.e. a set of the same but most often lower order OSs. Composition, for instance, refers to text documents written in natural languages, genetic codes, encryption codes, data files, voice signal/data files, video signal/data files, and any mixture thereof. A collection, or a set, of compositions is also a composition. Any content or piece of content is a type of composition and it is used instead of “composition” from time to time in this disclosure.
   3. Partitions of composition: a partition of a composition, in general, is a part or whole, i.e. a subset, of a composition or collection of compositions. Therefore, a partition of composition is also an Ontological Subject having the same or lower order than the composition itself as an OS. More specifically in the case of textual compositions, partitions of a composition can be characters, words, sentences, paragraphs, lines, chapters, webpage, etc.
   4. Ranking: ranking, is assigning a number, score, or feature or a metric to an OS among a set of OSs so as to assist the selection of one or more of the OSs from the set. More conveniently and in most of the practical cases the ranking is assigning a value to a partition of a composition based on a predefined relationship function. A relationship function, for instance, can be defined based on semantic similarity between members of a group of OS with each other or with another OS outside the group. For example similarity between a set of sentences with each other or between any sentence from the set with another, e.g. a given, sentence.

Now we start describing the invention in details. In this invention it is noticed that many applications can be viewed as finding or generating a piece of content in response to or as representative for another content. The applications may include generating a multimedia content for a given textual script, translating a composition from one language to another, or providing a response to a chatter input to a chatting machine or chat-robot, or simply getting some content generated which is related to an input or a given content.

Furthermore, semantics contain information that can be carried by symbols and OSs as defined in the definition section in the form of texts, data, and signals. Therefore semantics are carried and transmitted by symbols. In the world of semantics which is comprehendible by human, semantics are most efficiently transferred by natural language texts. Therefore, if the semantic information of different representation (i.e. video signal/data, audio signal/data, and texts in another language) is transformed to textual type and symbols, the semantic processing of the semantic information represented by different media can also be processed by text. Consequently, using the initial corresponding media representation of the semantics, one becomes able to convert the results of the semantic processing of the texts back again to the desired media representative e.g. visual, audio or textual. Accordingly we may first transform the semantics representation media to textual forms of a desired language, e.g. English, and perform our processing and calculation and finally represent the resultant composition of semantics by the desired media, language, form or type. That is the basic idea of the invention.

Accordingly, in this disclosure a method and system are given that can transform the representation of the information from one form, shape, or language to another by capturing and regenerating the essence and semantics of the original information and represent it with another piece of content, having perhaps a different media type, language, or form, according to predefined relationship functions between the given content and the represented content. An interesting application of the method is, of course, to transform a text message to a multimedia clip using pre-built or pre-existing multimedia contents.

In another aspect, a method is given, for instance in it's general form, for converting a given multimedia content to another multimedia content using pre-built or pre-existed multimedia content or their partitions to compose a new content. The partition of the composed content and the partitions of the given content have certain pre-defined relationship. However, as mentioned, since semantics can be best processed by textual representation therefore we focus on transforming a given textual information or content to other contents with the same or different type. The given textual content could have been extracted from a multimedia content itself. In the preferred embodiment, according to this disclosure, the generation of content for a given content is done automatically for an input content and/or and at the request of a user or a client/s. For example, textual compositions to visual/audio compositions which are semantically similar or expressing a pre-defined semantic relationship to the given content. The given content and the composed content can belong to different languages. For example the language of the given content could be English and the language of the composed content be Spanish.

The method uses the existing or pre-built contents, single or multimedia, to generate new representative contents for a given content. Although, the method is applicable for transformation of all types of contents (even with different languages) and compositions to each other, in the detailed description the method is explained by way of a general exemplified case of transforming a textual content to a multimedia content. That is because a multimedia content can also be semantically represented by a textual content. Therefore for ease of explanation we assume the given content is textual. The given content therefore can be any textual composition, i.e. textual OSs, such as keywords, a date, a subject matter, a sentence, a paragraph, a short script, short and long essay, or a document in any language. The given textual content furthermore could have been generated for another content in general, e.g. an initial given content is a sentence and the secondary given content could be a number of sentences or statement semantically related to the first given content (the given sentence) and therefore our assumed given content could be a representative content itself.

Now the invention is disclosed in details in reference to the accompanying figures and exemplary cases and embodiments in the following sub sections.

### II—EXTRACTING THE OSs OF DIFFERENT TYPES AND ORDERS FROM A MULTIMEDIA COMPOSITION

According to an exemplary embodiment of the invention, a plurality of multimedia contents or a set of segments of multimedia contents are obtained from which the Ontological Subjects of different types, e.g. textual, audio or aural, visuals, are extracted from partitions of the set of said multimedia contents.

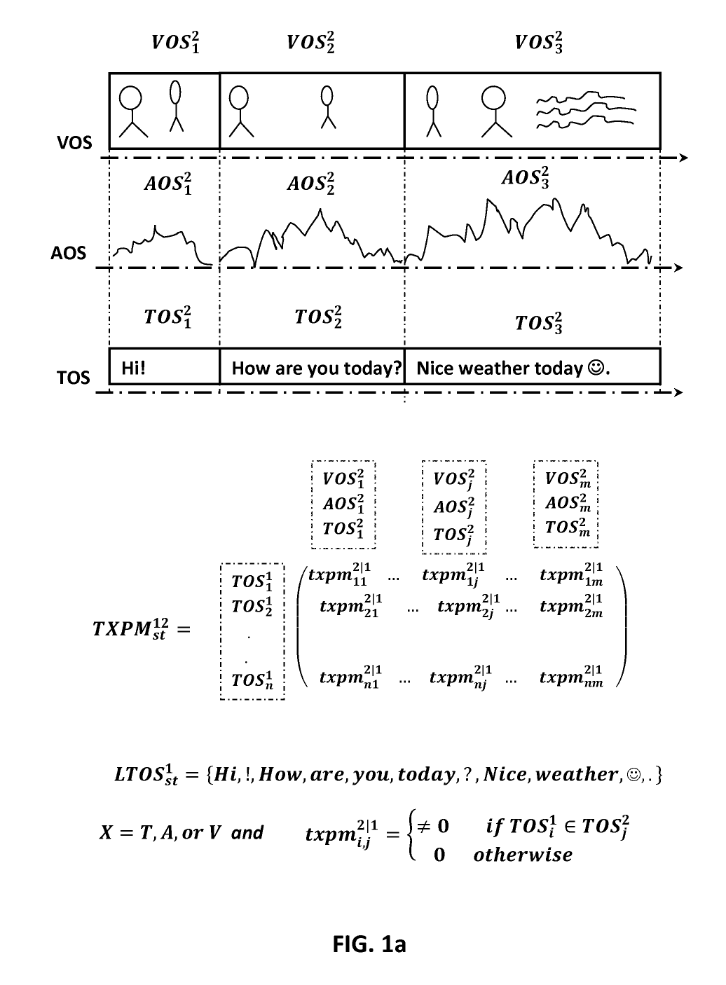

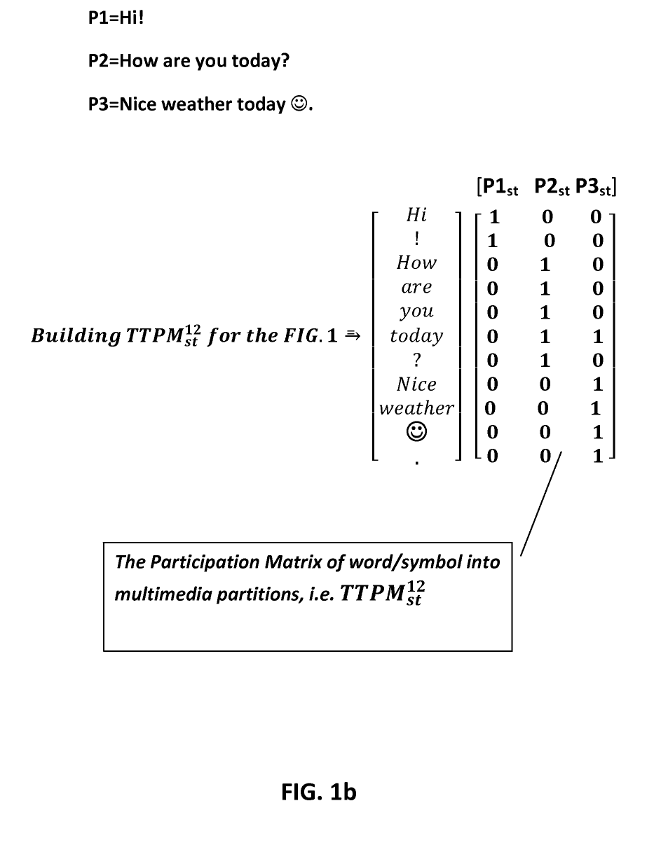

Referring to FIG. 1a now, there is shown a conceptual schematic of the process and the method of getting the ontological subjects of deferent type which are describing a similar semantics. For instance a sentence contains few words is a TOS of order 2 which is composed of a plurality of words as TOSs of order 1. The same sentence then can also be corresponded to an AOS of order 2 that is an audio representation of the same sentence as someone is reading that sentence back. The AOSs can, for example, be a partition of electrical analogue signal (e.g. as shown in FIG. 1a) or a string of digital signal, corresponding to a vocal, dialogue, or speech. Similarly, also shown in FIG. 1a, there are VOSs indicative of a visual partitions of a visual scene. By the same way, a video partition or a clip, or a picture can be corresponded to a TOS or an AOS that conveys similar meaning or pointing to a similar or related semantics. The semantics of TOS and AOSs can be perfectly matched and be basically the same, however a VOS can correspond to various TOSs or AOSs. Nevertheless, for simplicity we often can consider the case where there is a one on one mapping relation between the TOSs, AOSs, and VOSs.

Therefore if one can have semantically similar or matched partitions of OSs of different nature, type, or language then one can transform a composition of one type of OSs, e.g. a textual composition, to another form or type of composition, e.g. visual or audio. Accordingly in this disclosure, in order to get semantically related TOS, AOS, and VOSs we should have a repository of OSs of different types. To build the repository, one exemplary convenient way is to start with the available or premade multimedia contents and separate their ontological subjects of different types with the desired orders. Alternatively it is possible to have a pre-built database or filing systems of audio, visual, and textual partitions of related, similar or the same semantic content.

Referring to FIG. 1a again, it shows an exemplary multimedia content or simply a video clip showing a conversation between two people somewhere. FIG. 1a is demonstrating the method and the concept of the invention for a simple exemplary case. The top part of the FIG. 1a basically demonstrates that a simple composition or content can be conveyed by text or audio and visuals. As is the case most of the time, the video clips or a multimedia content contain at least a visual and an audio part, wherein from the audio part the textual content can be extracted by voice recognition or audio to text conversion methods and software or even by human operator. However there are many other sources that the text of pre-existing multimedia contents can be obtained, such as free repositories of movie scripts, or song lyrics, if it is not included in the multimedia file that is stored in a computer readable medium. Therefore in FIG. 1a we assume that we have the text of the conversation or have extracted it from the audio part of the video, or an operator had extracted the texts of the speeches given by the characters, or description of the visual scene by text. In FIG. 1a, from the text we have partitioned the clip to three semantically independent parts. The partitions are selected in such a way that each part can be independent and meaningful. The partitions therefore, although not necessarily, usually are sentences, or syntactically correct form of a semantic frame wherein according to our definitions each part can be considered as a textual ontological subject of order 2, i.e. TOS².

Referring to FIG. 1a once again, the conversation “Hi . . . How are you today? . . . Nice weather today [symbol] .” is partitioned to three parts which again according to our definitions each part can be considered as a textual ontological subject of order 2, i.e. TOS². Consequently each partition is shown in a textual frame which is referred to by TOS₁², TOS₂² and TOS₃² in FIG. 1a.

Also shown in the FIG. 1a, are the corresponding audio and visual, i.e. AOS² and VOS² partitions. Conventionally the audio and visual partitions are usually divided in time frames.

Therefore we can have three kinds of representations here which are referring basically to the same or similar semantics or semantic partitions or frames. As mentioned the desirable semantic partitions here are usually the sentences which were pronounced in the clips or would be pronounced in the composed clip as we will discuss later in this disclosure.

The partitions consequently can be indexed and kept, temporal or permanent, in databases or file systems for easy retrieval and later use or processing.

Also shown in FIG. 1a, there is provided a list or set of words and characters used in the conversation that again according to our definitions is denoted by List of Textual Ontological Subject of order 1, i.e. LTOS¹ which is shown in the lower part of FIG. 1a by LTOSₛₜ¹ to indicate that this list is stored (temporary or more permanently). It is really a matter of notation differentiation, it is understood that any other forms, numbers, strings and references can also be given to LTOSₛₜ¹, therefore it should not necessarily been stored in a hard disc or optical storage, or FPGA circuit or the like but LTOSₛₜ¹ and all other objects for that matter, can be made and kept in temporary storage means such as RAM or ROM.

In general case the number of pre-existing or prebuilt multimedia contents and partitions could be very very large and diverse, so the number of Ontological Subjects of any type and any order becomes large thereby making a large repository and inventory of most of the practical and routine visual scenes and the associated texts and the vocal conversation etc.

### III—BUILDING THE PARTICIPATION MATRICES

Referring to FIG. 1a again, in the middle there is shown a general participation matrix which basically shows the participation of each word or character, i.e. each member of the set of LTOS¹, in one or more of each of TOS², or its corresponded AOS², or its corresponded VOS² partitions. Therefore the general PM matrix is denoted by TXPMₛₜ¹² to indicate the PM shows or contain the information about the participation of textual ontological subjects of order 1, into either of, TOS² or AOS², or VOS². That is to show that X can be replaced by T or A or V so that the name of the participation matrix would become TTPM¹², TAPM¹², and TVPM¹² respectively. Therefore, in this exemplary case, the rows correspond to the textual ontological subjects of order 1, e.g. words and meaningful characters, and the columns are related to either of textual, audio or visual partitions.

The general stored participation matrix is denoted by TXPMₛₜ¹², and take the following form:

$$\begin{matrix}{VOS}_{1}^{2} & {VOS}_{j}^{2} & {VOS}_{m}^{2} \\ {AOS}_{1}^{2} & {AOS}_{j}^{2} & {AOS}_{m}^{2} \\ {TOS}_{1}^{2} & {TOS}_{j}^{2} & {TOS}_{m}^{2}\end{matrix} \\ {TXP}_{st}^{12} = \begin{matrix}{TOS}_{1}^{1} \\ {TOS}_{2}^{1} \\ ⋮ \\ {TOS}_{n}^{1}\end{matrix} ( \begin{matrix}{txpm}_{11}^{2 / 1} & ⋯ & {txpm}_{1 j}^{2 / 1} & ⋯ & {txpm}_{1 m}^{2 / 1} \\ {txpm}_{21}^{2 / 1} & ⋯ & {txpm}_{2 j}^{2 / 1} & ⋯ & {txpm}_{2 m}^{2 / 1} \\ & & & & \\ {txpm}_{n 1}^{2 / 1} & ⋯ & {txpm}_{nj}^{2 / 1} & ⋯ & {txpm}_{nm}^{2 / 1}\end{matrix} ) \qquad ( 1 )$$

where:

$$X = T , A , or V and {txpm}_{i , j}^{2 / 1} = \{ \begin{matrix}\neq 0 & if {TOS}_{i}^{1} ∈ {TOS}_{j}^{2} \\ 0 & otherwise\end{matrix} .$$

The index “st” stands for “stored” and show that this matrix is built for multimedia partitions of pre-existed multimedia contents and is stored (temporarily or more permanently). However in implementation of the method the PM can be stored or shown by other forms and instruments such as lists, lists in lists, dictionaries, cell arrays and so on which basically contain the information of participation of one OS in another OS. The current notations and formulation is for ease of explanation and calculation and should not be interpreted as the only way of implementing the method's concept in actual implementations.

The entries of the PMs are nonzero if the words or character is used or participated in the partitions of the text, the audio or the video, and is zero otherwise as indicated in the FIG. 1a as well.

The matrix TXPMₛₜ¹² carry the most important and useful information related to the multimedia partitions. It can be used to summarize a large multimedia content, cluster and classify the partitions and/or be used for searching thorough large number of multimedia pre-existing partitions and finding the most semantically related multimedia partitions in response to a query and building an effective multimedia search engine. The applications of participation matrices have been explained in the patent application Ser. No. 12/755,415 filed on 7 Apr. 2010 which can be used readily in here. However in this embodiment we are more focused in composing new multimedia compositions using pre-existed multimedia contents because it uses the most general use of PMs besides being able effectively to search and sift through partitions in response to a given content or query.

Referring to FIG. 1b now, it shows more explicitly what we mean by participating matrix and how they are made as the figure is self explanatory. In this exemplary case, we basically extracted the sentences (or any other textual partition desired) and the desirable words and characters and built a matrix in such way that shows which word has participated in which partitions or sentence/s (e.g. P1, P2, and P3 in FIG. 1b) by setting the corresponding entries of the TTPM matrix to value 1, (could be set to any other nonzero value in the more complicated embodiments) and zero value if not participated. Therefore the resulting participation matrix would be TTPM¹² (i.e. participation of TOS¹ to TOS²). It is worth to mention here an important case, in which TOS² can be from different language or be a semantic representative for another TOS² of a different language than the language of TOS.¹

However there could be built various other Participation Matrices and with different orders, such as TVPM²² or AVPM²². For example TVPM²² shows the participation information of sentences into their respective visual clips in which the visual clips would usually be a data file object, rather than a text string, where they can be referred to by their file names. In practice only the textual representation of the audio and visual partitions is enough for performing the calculations and processing the semantic information. Moreover texts of different languages can be used to built a PM. Assuming there is a collection of textual contents from one language, one can partition the text of the first language and find the semantically related, e.g. similar, textual partitions from the second language and build a part TTPM^{lm} wherein the first T belongs to one language and the second T belongs to a different language.

The purpose of making a list of all type of OSs and building the PMs is to have them stored as an inventory of building blokes of a multimedia that on demand can be fetched or retrieved and be used in a new multimedia composition. Nevertheless these software objects can be built on demand and in real time. So from a large number of multimedia collections we build a list of TOS¹ and TOS² extracted from the partitions of those collections and corresponding them to the respective visual and audio OSs. Consequently the participation matrixes are built that essentially carry the information about the usage of each lower order OS, specially the TOS¹ in higher order OSs. These stored data and information are for both retrieval facilitation and numerical calculation such as calculating the similarity measures between OSs as will follow later on in this disclosure.

In an actual and practical uses it is desirable to have it stored a large inventory list of visual partitions, along with a large list of their textual and audio partition so that databases can accommodate any or at least most of hypothetical retrieval requests, from a client, user or a software engine, demanding a predefined relationship with their prospective representative content.

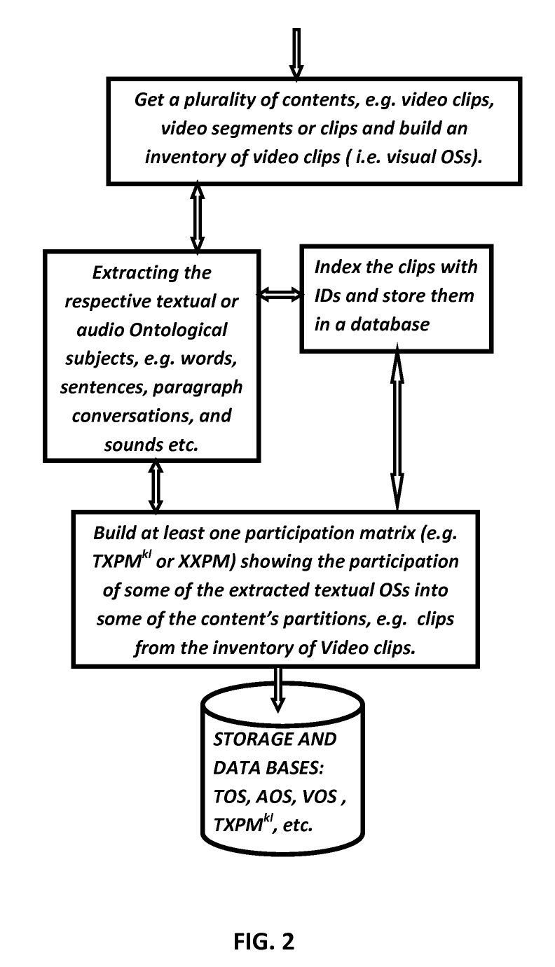

FIG. 2 shows TOSs and AOSs of a plurality of video clips that are extracted and stored in a list as well as indexing and storing the partitions in database. The participation matrixes are further built which indicates in each visual clip the words and the sentences that have been used. For simplicity and practicality one can assign the rows of the matrix to reference to the words from the list of the words and the columns of the matrix to reference the clip number that they have been used or appeared or the sound tracks that they have been used wherein the clip number can conveniently refer to a file in a filing system.

In this embodiment we construct a library of video clips of real videos, animations, comic scripts, pictures, etc. that are conveying a semantic unit (or segment) or a number of semantic units that might be related. Semantic units here are meant as short semantically meaningful and/or a combination of semantics which can describe an event or object or an abstract idea. For instance an English word is a semantic unit referring to an entity, a symbol, or state of an entity and the like whereas in here a sentence that is composed of a subject, verb, and an object can also be considered a semantic unit too. Therefore semantic units can use combiner or connectors to form a larger semantic unit.

Referring to FIG. 2 again, the method in this embodiment is using a system that have access to a set of multimedia contents that can contain, video and audio, e.g. classic movies, or movie with subtitles, or cartoons, user generated videos, graphics, images, and any combination of content representation forms in and for any language. The ontological subjects of a multimedia content are extracted and separated by their type into a list. The textual partitions yet are parsed into desired words and characters and at least one participation matrix is constructed.

One simple way to get the text and extract and partition the OSs of different orders and types is to convert the audio to text or get the text from the subtitles of the movie and clips when there is one included in the multimedia. Nowadays most of DVDs also contain the text of the conversations and almost the scripts of the movie. Moreover there are numerous, freely available, repositories of movies and their text and scripts and many user generated video clips are also available. However, in reality legal issues related to copyrighted materials and contents must be taken care of by certain arrangements which are not the main points of this description.

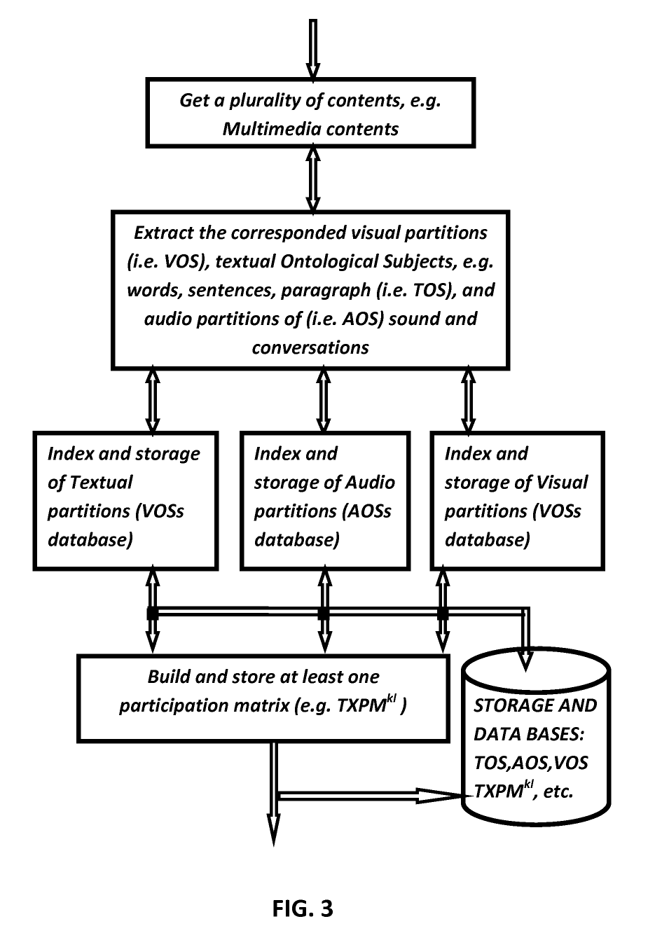

Referring to FIG. 3 now, it shows in more detail the method and the system employed in this invention to extract and store the Ontological Subjects of a set of multimedia content and builds the desired PMs as described above. In this embodiment, the XXPM can be made upon request real time or can be made and stored in the databases for later use or processing or make it available once is needed.

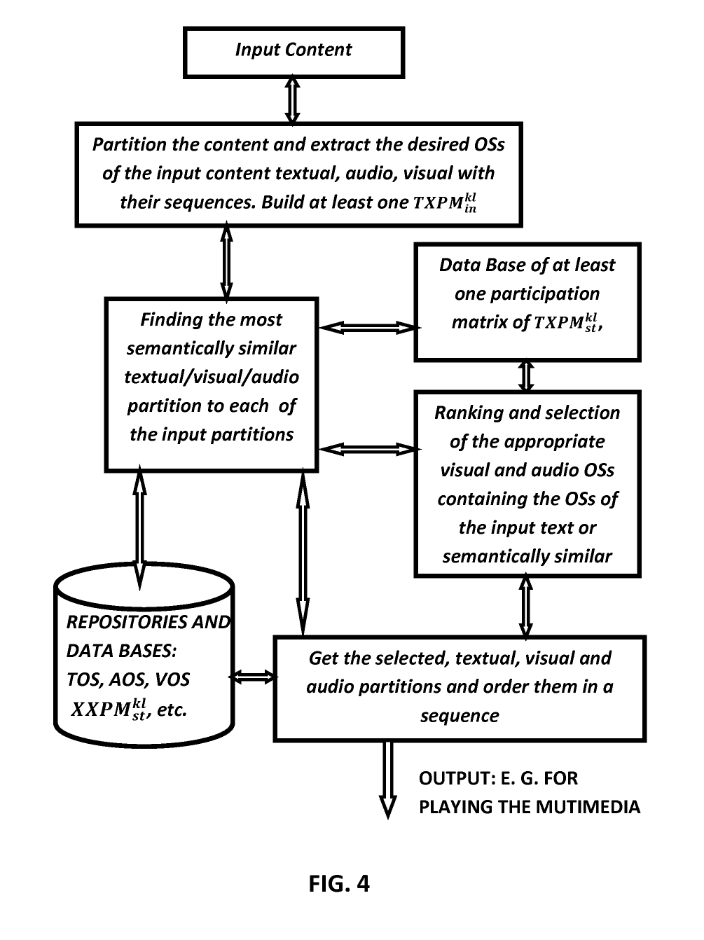

FIG. 4 shows one exemplary and simplified schematic of block diagram of a system and process of generating a multimedia content according to an input content from a user as a given content. As shown the text of the input content is extracted and partitioned to appropriate semantic segments, such as sentences and short paragraphs and kept in a list preferably in the same sequences as they have been appeared in the text of given content.

In one special and important case input content in the FIG. 4 can be a textual composition. Based on the explanation above, it is clear that the audio input or a multimedia content can also be used for generating a new multimedia composition in a similar fashion so for composing a multimedia we only consider textual input in the form of real text, movie scripts, SMS, text of a foreign language, etc.

Accordingly in FIG. 4, the input text is partitioned to a desired number of partitions and the partitions are also further parsed to desired OSs. In the preferred embodiment the text is partitioned to sentences, as textual second order ontological subject i.e. TOS², and the sentences can further be decomposed to its constituents words and special characters as TOS¹. Then making a list of input TOS² which can be denoted by LTOSᵢₙ², and a list of input TOS¹ which can be denoted by LTOSᵢₙ¹, subsequently building a participation matrix of TTPMᵢₙ¹² similar to the one which was built for our repository of multimedia partitions in FIG. 1a, i.e. TTPMₛₜ¹².

Now using the information of TTPMᵢₙ¹² and TTPMₛₜ¹² we can find the best semantically matched partitions (from the stored pre-existed multimedia partitions) for the input partitions in order to assemble a multimedia composition for the input text or audio. Particularly when someone translate or substitute one or of the TOS¹ in the LTOSᵢₙ¹ or LTOSₛₜ¹ she/he can get a desired relationship, e.g an antonym relation, between the partitions of the input with the stored partitions.

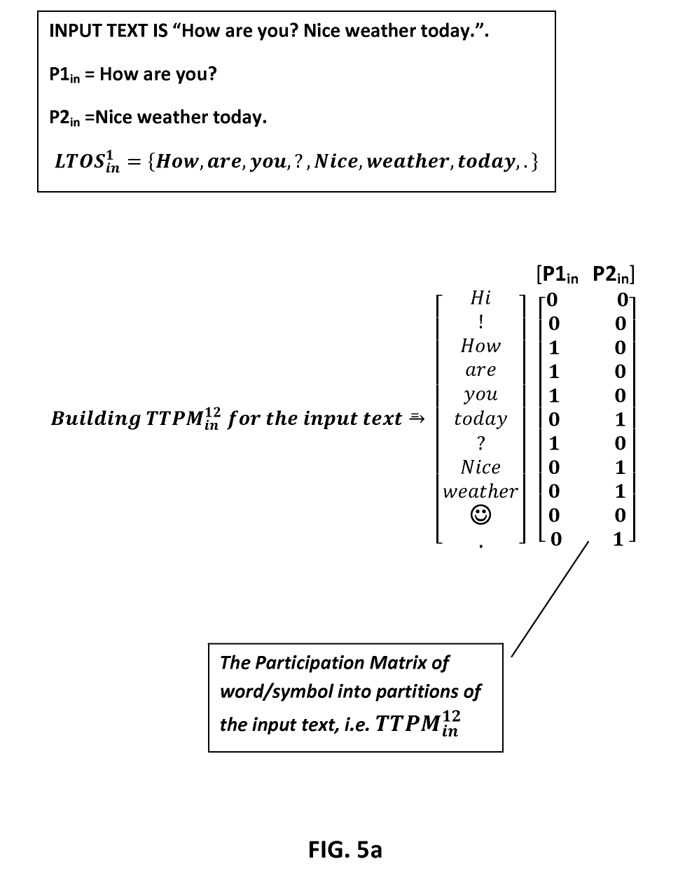

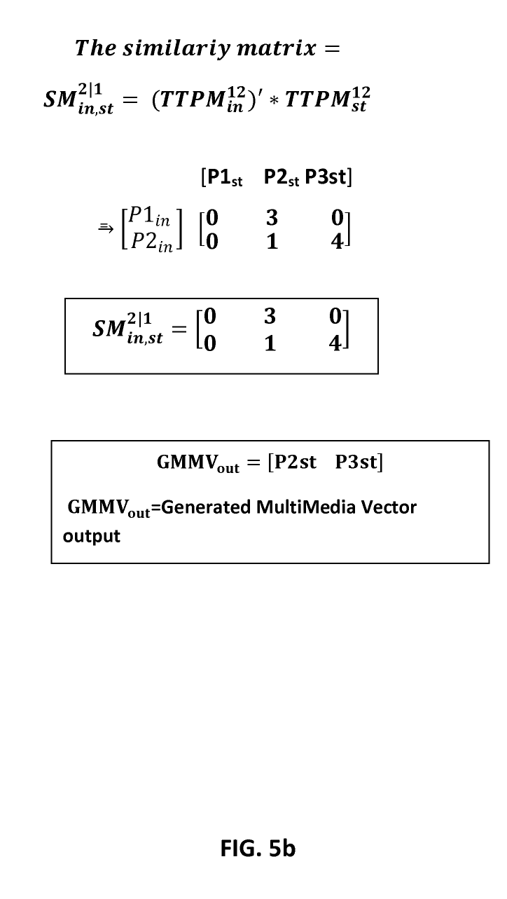

FIG. 5a shows a simple exemplary case of demonstrating the method to find the best matched partitions of the multimedia partitions. In this case assume the text of the input content is “How are you? Nice weather today!.”, that contains two simple partitions or sentences. Again here we built a participation matrix for this input textual composition and calculate the similarity matrix if the desired predefined relationship function is the semantic similarity between the partitions of the given text and the stored partition.

However in FIG. 5b, we consider the case of semantic similarity relationship to demonstrate the method in detail. Turning to FIG. 5b now, it shows one exemplary way of calculating the similarities of input partitions and the stored partitions using the constructed from input and stored participation matrixes. The Similarity Matrix (SM) of the partitions of the input text and the stored partitions of the multimedia is given by:

SM_{in,st}^{2|1}=(TTPMᵢₙ¹²)′*TTPMₛₜ¹². (3)

In Eq. (3) the “′” shows the matrix transposition operation and SM_{in,st}^{2|1} is the similarity matrix shows the pair-wise similarity of each of the partitions of the input compositions with each of the stored partitions.

For the above exemplary cases of the stored partitions and the input partition the resulting similarity matrix is:

$${SM}_{in , st}^{2 / 1} = [ \begin{matrix}0 & 3 & 0 \\ 0 & 1 & 4\end{matrix} ]$$

which shows the first partition of the input content is most similar to the second stored partition and the second partition of the input content is most similar to the third stored partition (where the similarity coefficient, i.e. the entry of similarity matrix, in each row is maximum). Hence the second and third partitions of the stored repository of multimedia partitions will be the best suited representatives of the input text and the Generated Multi Media Vector (denoted as GMMVₒᵤₜ and shows the sequence of output partitions) as the output of the Multimedia generator will be:

GMMVₒᵤₜ=[P2stP3st].

The GMMVₒᵤₜ is therefore used for assembling and playing the generated multimedia corresponding to the input text from the stored inventory of the multimedia partitions. In general when the numbers of stored partitions are large enough there could be found more than one representative contents with high similarity with one or more of the input partitions. Therefore there is also a possibility to choose more than one representative partition from the stored partitions to one of the input partitions.

It should be mentioned that P2st and P3st can be either the audio part or visual parts of different pre-existed multimedia contents or both can belong to the same pre-existed multimedia contents as long as they are corresponded to the same textual partitions (for the case of semantic similarity relation). In other words the process can independently be done for text to audio conversion in demand or text to visual conversion in demand and if desired combing the audio and visual parts of different origin to generate new multimedia compositions. In general, the audio and the visual partitions can be selected from independent pre-existed multimedia contents or different sets of multimedia contents.

Furthermore the attributes of the representative partitions or the generated content in general can be modified before or after assembling the generated contents. For instance characteristics, attributes, and semantics of the generated content can be altered from their pre-existed form. Voices can be filtered by signal equalizers, videos, and visuals can be distorted or changed, visual colors can be modified and changed, or even the semantics can be altered or substituted with other symbols or ontological subjects.

There could also be other types of relationship that can be defined such as an antonym or semantically opposite type of relationships. In this case one can substitute the words or the partitions of the input content with their antonym by consulting with a word dictionary, taxonomy, ontology etc. For implementation one can translate or substitute one or more of the initial TOS¹ in the LTOSᵢₙ¹ or LTOSₛₜ¹ with one or more TOS¹ that have predetermined or predefined relationship with the initial TOS¹ and get a desired relationship, e.g. an antonym relation, between the partitions of the input with the stored partitions using the calculations above.

Another relationship function can be defined as a measure of semantic context similarity, by replacing some of the words or partitions of the input content and/or the words or partition of the stored content with their stems and senses, synonyms, similar words, associated words, or any other words and partitions which deemed desirable. Semantic context similarity in particular might be useful in order to increase the chance of finding matches and representatives for the given content. One way to find semantic context similarity between the partitions is to replace groups of words and phrases, having similar meaning or stem, with one common word or phrases, wherein the replacement for a similar group of words derived from a dictionary or ontology such as WordNet collections as explained in the patent application Ser. No. 12/755,415.

Another way to get a predefined contextual relationship, while still using Eq. (3), between the partitions of the input content and that of the generated or found partitions from the stored repository of partitions of the contents is to replace words, i.e. TOS¹ of initial TOS¹ in the LTOSᵢₙ¹ or LTOSₛₜ¹ with one or more TOS¹ that are semantic associates of the initial TOS¹, having predetermined association strength to each other in order. The contextual similarity or contextual relationship case is interesting in practice for finding or generating short or long answers in response to a chatter's input or a questionnaire input in which the response and the input are somehow related but not each others mirror so that there could be, for instance, a meaningful conversation between a chatter and a machine. Therefore similarity matrix concept can be used effectively in the implementation and calculation to find one or more partitions from the stored partitions having desired relationship with one or more of the partitions of the input composition or content. For instance the similarity matrix, SM, can even be used to find semantically opposite or non-similar partitions.

Going back to the FIGS. 5a and b and the described formulation and method, the exemplary embodiment uses the simplest form of similarity measure for illustration purposes. However, more sophisticated measures of similarities can be envisioned and devised as explained in the patent application Ser. No. 12/755,415 referenced earlier.

It is also noticed that the list of words and character, i.e. the rows of both PMs, can be either chopped or extended to have the same number of participating ontological subjects. Those competent in the art can simply realize that there are various embodiments to make the building of similarity matrix possible by either extending or chopping one or both lists of the words and characters form the input text and/or from the stored list so that the multiplication (i.e. Eq. (3)) is possible. Depending on the definition of the similarity measure the appropriate list of OSs, e.g. LTOS¹, or row dimension of both matrixes can be determined. For instance, it is possible to only consider those stored partitions that contain at least one common word with one of the partitions of the input content, in the calculation by, for example, combing them out their corresponding rows of the TTPMₛₜ¹².

In general other forms of similarity measures can be defined as:

SMij_{in,st}^{l|k}=ƒ(Piᵢₙ^{kl},Pjₛₜ^{kl}) (4)

where SM_{in,st}^{l|k} is the similarity matrix of OSs of order l given k derived based on the participations of OSs of order k in the OSs of order l of input and the stored ones, Piᵢₙ^{kl} and Pjₛₜ^{kl} are the ith and jth column of the TTPMᵢₙ^{kl}, and TTPMₛₜ^{kl} respectively and corresponds to the partitions of input text and that of the stored partitions. Also ƒ is a predefined function or operator of the two vectors Piᵢₙ^{kl} and Pjₛₜ^{kl}. The function ƒ yields the desired similarity measure and usually is proportional to the inner product or scalar multiplication of the two vectors.

In one preferred embodiment the similarity of partitions can be given by:

$${smij}_{in , st}^{l / k} = \frac{{pi}_{in}^{kl} \cdot {pj}_{st}^{kl}}{‖ {pi}_{in}^{kl} ‖ \cdot ‖ {pj}_{st}^{kl} ‖} , \qquad ( 5 )$$

which is the cosine similarity, i.e. correlation, measure and in fact shows the similarity between partitions of the input composition and that of the stored partitions in the system. This similarity measure is between zero and one.

Alternatively, in many cases the similarity measure is more justified if one uses the following formula:

$${smij}_{in , st}^{l / k} = \frac{{pi}_{in}^{kl} ⋀ {pj}_{st}^{kl}}{{pi}_{in}^{kl} ⋁ {pj}_{st}^{kl}} \qquad ( 6 )$$

where Piᵢₙ^{kl} [symbol] Pjₛₜ^{k1} is the number of common OSs of order k between Piᵢₙ^{kl}, i.e. OSiᵢₙ^{l}, and Pjₛₜ^{kl}, i.e. OSjₛₜ^{l} (the inner product of binary vectors of Piᵢₙ^{kl} and Pjₛₜ^{kl}) and Piᵢₙ^{kl} [symbol] Pjₛₜ^{kl} is the total number of unique OSs of order k for the combined Piᵢₙ^{kl} and Pjₛₜ^{kl} (i.e. the summation of logical OR of binary vectors of Piᵢₙ^{kl} and Pjₛₜ^{kl}).

Having obtained the similarity measure of input partitions and the stored partitions, for each input partition the one or more most semantically similar partitions of stored OSs of the desired type can be selected to be used as the representative of that particular input partition. Usually the sequence of the partitions would be the same as the sequence of the partition in the input textual or audio composition.

One may built an inventory of content partitions, e.g. video clips, in house to have a pre-built repository of multimedia clips, or visuals, and audio clips corresponding to a plurality of textual contents, such as a list of sentences, phrases, statements, essays, etc. In this case she/he normally has an inventory of pre-built video shots, animations, avatars, 3D animation etc., with their corresponded textual dialogue or description of the scene.

In practice the repository of stored partitions of the set of the original (pre-built) or pre-existed multimedia contents can include several tens or hundreds of millions of partitions almost semantically covering all partitions of possible input compositions to the system. Moreover there will be many choices of classes of visuals, audio, voices, and languages that can represent the input composition or content. Those masterful in the art can devise and introduce efficient numerical methods and alternative formulations to efficiently calculate the similarities or any other desired semantic relationship values, finding and retrieving the most desired and appropriate stored partition to be used in the generated multimedia without departing from the scope and sprit of the current disclosure.

More importantly, though in the illustrating example we were more focused on finding the visual partitions for the input text or audio, it is possible, by the same concept, to find the most semantically similar audio partitions for the input text or an input aural or in general any input multimedia content in any language which might not be the same as the stored contents. Therefore in the generated multimedia it becomes possible as an option to a user to choose the voice, language, and the visual to represent an input composition or content. The voice, language, and visual partitions in the generated multimedia should not necessarily belong to the same pre-existed multimedia content. Therefore the method can also be used to generate cross-language contents or multimedia content.

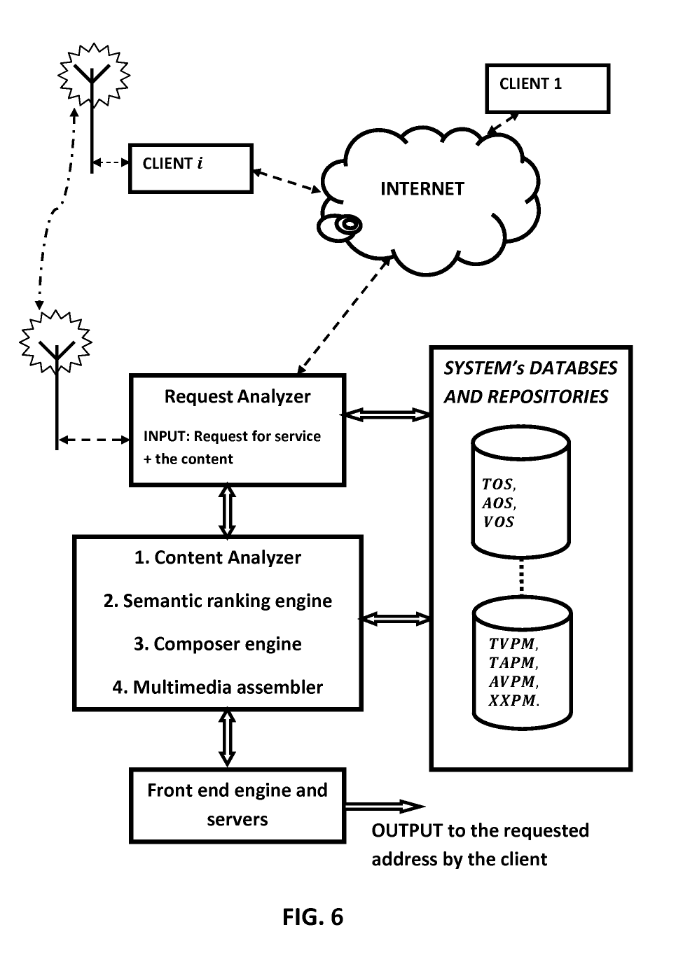

Referring to FIG. 6 now, it shows an exemplary system of client and server application through internet or any other communication media such as mobile network, private networks, TV broadcasting, etc. As shown the system receives a request for service from a user in a predetermined form and formats such as a text, digits, clicking a button, or audio signal etc. For using the service the user is further required to input a content of his/her or it's own such as file, text, audio, visuals and the like to the system. The user's input can be single keyword or even be a multimedia content that is intended to be converted into another content composition or anther multimedia content which is semantically related to the input multimedia content.

The system consists of hardware and software programs needed to store the databases, obtain and process pre-existed or pre-built contents, perform the algorithms, and process the requests of clients and receive user input content from the user's computer devices or across a communication network. Customarily the system will include processing units of variety of type and physical mechanisms, computer servers and software packages for serving the client in the frontend or working for the client request at the backend engine and fulfill the client request (e.g. web servers, file servers, application servers, etc.).

User's Computer devices can include laptop, desktop computers, handheld computer devices, mobile phones, any point of connection to the internees terminal, workstation computers, gaming machines and generally any electronic device capable of sending, receiving and processing data thorough communication and computer networks. Said electronic devices or computers can be connected to networks by network interfaces via wires, cables, fiber optics, or wireless networks of current and/or future generations and technologies such as Wi-Fi, WiMAX, 4G networks, etc.

In describing an exemplary service of the system in FIG. 6, we again focus into generating a multimedia content for a client's input or an input content because of the generality of this case. Obviously, as described throughout the description, other forms of content types can be generated by the system in the same manner using pre-existed or pre-built contents of variety of types.

Continuing therefore with describing FIG. 6, as shown there is a request analyzer which analyze the request and decide where and which ones of the servers and repositories are best suited to fulfill the request. The system also has the ability to build the repositories on request or has access to premade databases such as the databases shown in FIG. 3. After processing the client request the system composes the multimedia content corresponded to the user provided content and the requested style, relation, or special character or genre etc., and make it available to the user. The user can also request and chose to share the generated multimedia with others, send it to other users or send it to the user or the address/s or electronic address/s, websites etc., that was provided or selected by the user, through internet or any other means of communication or any device and apparatuses suitable to serve the client's request.

The system can also contain the processing units and software and storage apparatuses to perform the algorithm and storing the partitions of pre-existing or original pre-built multimedia contents from different sources and store them in its databases for other parts or units of the system to use. The stored partitions can further be classified and stored in the database based on their features such as genre, characters, time of production, subjects, serial name, characters' voices, type, required bandwidth or any other conceivable feature that can cluster or classify the pre-existing media contents.

A user can chose a real or animated character with a voice of the same or the voice of another preferred character, even the user's voice, to represent the user in the generated multimedia. Moreover a repository of movie collections can be turned into animated version, which many people might find more entertaining, and from which users can chose from. Therefore using the method and the system disclosed here with the combination of available voices and visuals one can have an endless opportunity to compose multimedia contents as representations of even a single input composition.

The method, system and service can be applied to perform many useful services, such as real time conversion of call conferences to multimedia conferences, educational and presentation purposes, entertainments, and fun etc.

One of the possible applications of such a system and method of multimedia generation is for aspiring or casual content creators who quickly want to prototype their textual or audio content turned into a multimedia content. Moreover they can use the system and method to capitalize on their content creation talent.

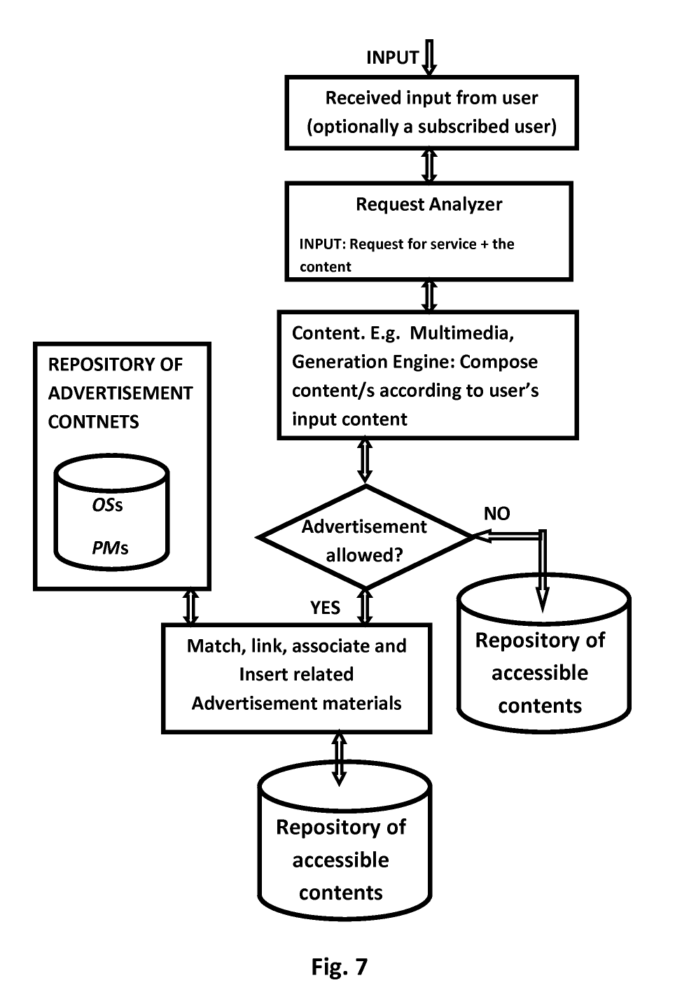

Optionally the content creators and the service and system provider can capitalize on their creation and investment as depicted in FIG. 7 as an exemplary way of generating incentive to the content creators and system and service providers.

Referring to FIG. 7 here, it shows a system and method of providing a system for variety of clients so that individual composers can use to benefit from the method and the system described in the disclosure. The system as a content or multimedia generator will assemble a content or multimedia content for the user according to his/her inputs and his preferred options such as the choice of language, text format, character/s, the genre, the voice, the music etc. Moreover, the system will provide an opportunity to the users (optionally subscribed to the service) to be able to generate income by inserting related advertisement martial along with the generated contents and multimedia contents and share the income with creator. The related advertisements can also be found by the similar method as finding the most semantically matched or semantically related partitions to each other. Therefore in FIG. 7 there is a repository of advertisement content that has been stored and labeled in similar fashion as the pre-existed contents with the appropriate Participation Matrixes of its own type and order. For instance, once the content is generated by the system the appropriate and related advertisement content with the desired kind of relationship to the generated content can accompany or be inserted in the content or be linked to the generated content in any way viewable by user of the generated content. The appropriate and advertisement content can alternatively be selected from the input or given content too.

As a practical and general example of using such system in it's more complicated shape of service and operation, consider the animated television series of “The Simpsons” or the sitcom of the ‘Seinfeld” shows that was a hit during the 90's. Now if a talented creator composes single or episodic scripts and would want to use the characters of Seinfeld show, or the voices of Simpson's series characters for that matter, then she/he probably would find a significant number of viewers and audiences for her compositions (given that the semantics of the input script is well composed) by borrowing the characters of the Seinfeld show. Accordingly she/he would like and should be able to capitalize on her/his talent. One way is to allow the service provider or provider of the content generator to be able to insert advertisement materials in the composed content or multimedia from the user input composition. Of course the Seinfeld shows as well as many other in demand media contents are copyrighted. However there are possibilities to use copyrighted materials by various financial instruments such as licensing by the service provider, paying royalty, revenue sharing with the copyright holder etc.

Though the above hypothetical example is targeted at entertainment applications, nevertheless the disclosed methods and systems have many valuable applications in education, journalism, document translation, and rapid sharing of ideas and more effective communication etc.

Applications:

Few exemplary applications of the methods and the systems disclosed here are listed hereunder, which are intended for further emphasize and illustration only and not meant neither as an exhaustive application list nor as restrictive technical boundaries to the teachings of the invention nor the applications being restricted to these applications only.

1) Representing a text messages in the forms of short messaging services (SMS), emails, twitter texts, or even long essays and scripts, with other contents having different type, language, or media and/or length. In particular those texts would be more appealing and sometimes more informative if they are accompanied or transformed to a visual or audio message for conveying the same message as the text. For instance, a SMS can be converted to a multimedia message essentially conveying the same message as the given SMS but in a more entertaining and informative way.

2) Assisting to find and generate content for education, entertainment, artistic experimentations and many other desirable applications it can be quite useful to have a system with a method of converting a given content

3) The method can also be used for tagging and/or translating multimedia contents and/or their partitions so as to assist for efficient searching, ranking, and classifying collections of multimedia contents using the ranking methods of Ontological Subjects of different orders as disclosed in the patent application Ser. No. 12/755,415.

4) Converting and representing a summary or short note to a more comprehensive essay or multimedia, scripts to multimedia contents conveying the same essence and semantics.

4) Using the methods, a chat-robot or chatting machine can produce relevant responses to the input of a chatter so as to make the conversation between the user and the machine an intelligent conversation. A system can be envisioned that can converse with a user in which a user write or say something and the system, using the disclosed method, response back in some form or type of media content that has certain semantic relationship with the user input. Such system can be used as a Q&A service for users and clients wherein the system provides variety of contents for the user in response to his input (question).

5) In networks supporting mobile networking and communication one can use the method and system to provide content search and content generation ability and service to a mobile users through speech and voice recognition or mobile text messaging.

6) The method and system can effectively be used for content searches, e.g. multimedia searches, scoring relative to each other, and selections.

7) The method and the system can also be used for ranking the contents in a set of content. Specially ranking the multimedia content based on their substance in a set of multimedia content. The system and method can also be used by the same way for clustering and classification of multimedia content by calculating the relevancy, i.e. the values of the predefined relationship functions, a plurality of content to given content and then grouping the relevant content having passed predetermined relevancy threshold value and clustering those passed in a group or database, or files corresponding to the given content.

8) Assume a reporter or an amateur content creator want to have relevant highlights of a speech or speeches (perhaps from a famous speaker or personality) from some collection of audio or visual archives of the speaker by providing a content such as a keyword, statement or an essay. Furthermore, a simple statement can be turned into a content that also includes more known details in addition to the given content.

9) Small business owners can generate multimedia advertisement clips. Content creators and advertiser can find the related advertisement or interesting contents, e.g. visuals, for using into their advertisements to include with their content and on the other hand advertisers or agents can find the most suitable content to put their ad in. A creative writer (or an application developer) can transform her/his content into a multimedia and insert some advertisement into his generated content.

10) Visualizing a textual content to visually equivalent semantics using the pre-existing or pre-built visuals. Furthermore the textual content can further be enriched with more substances. For instance a textual statement states a particular fact about an entity can further be visualized by adding further information that is known about that entity. In other words generating a visual essay with a desired length for a given subject matter or a given content

11) Translating contents from one language to another. If the given content is in one language and the collection of pre-existing contents are in another language, one can generate participating matrixes in the same manner that is generated for variety of types, e.g. TVPMs, this time there is another type, attribute, or label for PMs which is the language of content. For instance one can translate a given text from language X to a representative text in language Y by making T_{X}T_{Y}PM using the partitions or OSs of both languages. For this application the partitions of the a plurality of pre-existed contents, e.g. textual, in language Y are translated, using human operators for example, to language X wherein there is a one to one mapping relation between the partitions of the pre-existed contents of language Y and the translated corresponded partitions in language X. Alternatively one can have a dictionary of translated pair of partitions from two different languages wherein the keys of dictionary are partitions in language X, and the values of the dictionary are the semantically equivalent partitions in language Y. Therefore the method can still be applied here to translate a given content in language X to be transformed to representative contents in language Y. In this case one use the collective contents that corresponds to the keys of the dictionary in language X to build one or more T_{X}T_{X}PM and perform the method using the information of said matrix, T_{X}T_{X}PM, and find the representative contents from the stored partitions of contents in language X, i.e. they key of said dictionary, and consequently find the equivalent representative content in language Y. Once there is a large enough TₓT_{Y}PM or its equivalent T_{X}T_{X}PM, i.e. large dimensions for PMs, the translation can be done effectively, and efficiently.

12) Comparing videos and audio in the form of electrical signals is very complicated and process intensive. However, once their semantic representation is transformed to textual contents, or tagged by textual partitions, then it would be easier to:
1. Sift through collections of video/audio signals and clips (searching and finding)
2. It would be possible to compose new videos and audio according to the textual content. For instance, using a textual description for musical partitions of a collection of musical contents, one can compose new musical contents by simply writing the description of the desired composition employing the disclosed methods of content generation.

The list above is not comprehensive and mentions a number of possible applications the methods and the related systems may be employed by users and service providers, and software developers. Those skilled in the art can use the teaching of the invention for employing in numerous other applications departing from the scope and spirit of the invention.

In summary, it is noticed that for most of the subject matters there is a great deal of contents in the form of texts, audio, video, graphics, pictures, etc. in any language and culture. It is usually very hard to compose a totally new content or creating a content that is not at least semantically related to pre-existed contents, without using the existing contents or their parts one way or another. However the content and the composition made of combined partitions of the collection of contents can be different from any of pre-existing contents. The composition's script can make a great differentiation between the contents. Therefore combining different parts of the already existing contents into a new combination can yield a new content and composition that can be very valuable, especially, if the content media is also being modified while keeping the essential semantics of a given content or script.

Accordingly, the invention provides methods and systems for generating representative content for a given content in various forms, types, languages, and media. The method uses pre-built and pre-existing content partitions in a new and modified combination to yield a new content which has predefined relationship with a given content. The methods therefore are instrumental in creating and generating new contents which can be accompanied with other media contents. The methods and the systems can assist average creators and contributors to regenerate, transform, and produce content of high value, substance, attraction and entertaining and pleasing for consumers of the content.

Those familiar with the art can yet envision and use the methods and systems for many other applications. It is understood that the preferred or exemplary embodiments and examples described herein are given to illustrate the principles of the invention and should not be construed as limiting its scope. Various modifications to the specific embodiments could be introduced by those skilled in the art without departing from the scope and spirit of the invention as set forth in the following claims.

### REFERENCE

1. US patent application of Hamid Hatami-Hanza for “System And Method For A Unified Semantic Ranking Of Compositions Of Ontological Subjects And The Applications Thereof”. Filed on Apr. 7, 2010, application Ser. No. 12/755,415.

What is claim is:

1. A computer implemented method for identifying a representative content for at least one partition of a given content, said given content being composed of at least one type of ontological subjects, comprising:
a. obtaining one or more contents, each of said contents are compositions of at least one type of ontological subjects,
b. partitioning the one or more contents to at least one partition having a predetermined type and order of ontological subject,
c. partitioning the given content to at least one partition having a predetermined type and order of ontological subjects,
d. calculating a value for a predefined relationship function between at least one of said partitions of the given content with one or more of the at least one partition of said one or more contents, and
e. selecting a sequence of one or more partitions from said at least one partition of said one or more contents, based on a predetermined range of values of said relationship function, as a representative content for at least one partition of the given content or for further processing wherein the representative connect is used for further processing.

2. The method of claim 1, wherein said type of ontological subjects is one of textual, aural, and visual.

3. The method of claim 1, wherein the steps of a, b, and c are performed in any logically possible order.

4. The method according to claim 1, wherein the method further comprises:
transforming the semantic representation of at least one partition of either or both of said one or more contents and said given content in such a way that at least one partition of the one or more content and at least one partition of the given content are semantically represented by a same type of ontological subjects and language.

5. The method according to claim 1, wherein said predefined relationship is a predetermined semantic relationship between at least one of said partitions of the given content with one or more of the at least one partition of said one or more contents.

6. The method according to claim 5, wherein said predetermined semantic relationship between partitions is semantic similarity of two partitions.

7. The method according to claim 1, wherein ontological subjects of the representative content have a same type or types as ontological subjects of the given content.

8. The method according to claim 1, wherein at least one of said selected partitions have a different ontological subject type from that of at least one of the at least one partition of the given content.

9. The method according to claim 1, wherein one or more of constituent ontological subjects of either or both of said one or more contents and the given content are replaced by one or more ontological subjects having a predetermined relationship with said replaced ontological subjects.

10. The method according to claim 1, wherein the ontological subject type of said at least one partition of the one or more contents and said at least one partition of the given content are both textual written in different languages.

11. The method of claim 1, wherein the at least one partition of one or more contents and the at least one partition of the given content are compositions of ontological subjects having one or more ontological subject types of textual, audio, and visuals.

12. The method of claim 11, wherein further comprises: modification of at least one attribute of the constituent ontological subjects of the representative content wherein the at least one of the modified attributes is in the following set:
a. semantic,
b. syntactic,
c. spectral frequency of audio,
d. frame rate of playing visuals,
e. visual colors,
f. visual features, edges, playing characters features, and
g. visual distortion.

13. One or more computer-readable media having stored thereon computer-executable instructions which, when executed by a computer system, cause the computer system to perform a method comprising:
a. instructions for accessing at least one compositions of ontological subjects as a first content,
b. instructions for partitioning the first content to at least one partition, said at least one partition have at least one type of ontological subjects of a predetermined order,
c. instructions for accessing a second composition of ontological subjects as a second content,
d. instructions for partitioning the second content to at least one partition, said at least one partition have at least one type of ontological subject of a predetermined order, and
e. instruction for selecting at least one partition from the first contents as a representative content for one or more of said partitions of said second content based on values of a predefined relationship function between one or more partitions of the first content and one or more partitions of the second contents wherein the selected partitions are used for further processing.

14. The method of claim 13, wherein said type of ontological subjects is one of textual, audio, and visual.

15. The method according to claim 13, wherein said predefined relationship is a predetermined semantic relationship between at least one of said partitions of the given content with one or more of the at least one partition of said one or more contents.

16. The method according to claim 15, wherein said predetermined semantic relationship between partitions is semantic similarity.

17. The method of claim 13, wherein the steps of a, b, c and d are performed in any logically possible order.

18. The method of claim 13, wherein the predetermined type of ontological subjects in the steps b and d are textual and wherein the method further comprises:
instructions for transforming at least one of ontological subject types of at least one of the partitions of the first or the second or both the first and the second content to a textual type of ontological subjects of a predetermined language.

19. The method according to claim 13, wherein constituent ontological subjects of the representative content have a same type or types as ontological subjects of the second content.

20. The method according to claim 13, wherein the representative content have a different ontological subject type from that of the second content.

21. The method according to claim 13, wherein one or more of constituent ontological subjects of either or both of the first and the second content are replaced by one or more ontological subjects having a predetermined relationship with said replaced ontological subjects.

22. The method according to claim 13, wherein the ontological subject type of said at least one partition of the first content and said at least one partition of the second content are both textual written in different languages.

23. The method of claim 13, wherein the at least one partition of the first content and the at least one partition of the second content are compositions of ontological subjects having one or more ontological subject types of textual, audio, and visuals.

24. The method of claim 13, wherein further comprises: modification of at least one attribute of the constituent ontological subjects of the representative content wherein the at least one of the modified attributes is in the following set:
a. semantic,
b. syntactic,
c. spectral frequency of audio,
d. frame rate of playing visuals,
e. visual colors,
f. visual features, edges, playing characters features, and
g. visual distortion.

25. A computer implemented method of generating multimedia content as a semantic representative for an input content comprising:
a. obtaining one or more multimedia contents,
b. partitioning the multimedia content to at least one partition having a predetermined type and order of ontological subject,
c. partitioning the input content to at least one partition having a predetermined type and order of ontological subjects
d. extracting textual semantic representation of at least one partition of the first content and at least one partition of the second content,
e. finding at least one semantically related partition from said at least one partition of said one or more multimedia content to the at least one partition of said input content, and
f. selecting a sequence of one or more semantically related partitions from said one or more partitions of said one or more multimedia content as a semantic representative of at least one of said at least one partition of the input content and making the sequence available for further processing.

26. The method of claim 25, wherein the input content is textual.

27. The method of claim 25, wherein the input content is audio.

28. The method of claim 25, wherein the at least one of the one or more multimedia content is composed of at least audio and visual ontological subjects.

29. The method of claim 25, wherein further comprises: modification of at least one attribute of the constituent ontological subjects of the representative content wherein the at least one of the modified attributes is in the following set:
a. semantic,
b. syntactic,
c. spectral frequency of audio,
d. frame rate of playing visuals,
e. visual colors,
f. visual features, edges, playing characters features, and
g. visual distortion.

30. A method of finding semantically related partitions of contents comprising:
a. having a first content decomposable to at least one partition,
b. having a second content decomposable to at least one partition,
c. making textual semantic representations of at least one partition of the first content and at least one partition of the second content,
d. assigning a score of semantic relatedness of at least two of the textual semantic representations of said at least one partitions of the first content and the at least one partition of the second content, based on a value of a predefined relationship function, and
e. selecting one or more partitions of the first contents having a predetermined values of said score of semantic relatedness as a semantically related content to at least one the partitions of the second content for further processing.

31. The method of claim 30, wherein one or both the first and the second contents are collections of smaller contents wherein said smaller contents require less storage space than either the first or the second content.

32. The method of claim 30, wherein one or both the first and the second contents are multimedia.

33. The method of claim 30, wherein one or both the first and the second contents are audio.

34. The method of claim 30, wherein one or both the first and the second contents are visuals.

35. The method of claim 30, wherein said textual semantic representation of the at least one partition of the first content and said textual semantic representation of the at least one partition of the second content are from different languages.

36. A system of generating contents for use over a computer or communication network comprising:
a. a client server environment,
b. a module for obtaining contents from their stored locations in the system or across the network,
c. at least one storage medium for storing a plurality of contents located in a predetermined place in the network,
d. module for having access to a given content,
e. a module for performing a computer implemented method of generating a representative content for the given content from the plurality of content comprising:
a. partitioning the plurality of contents to at least one partition having a predetermined type and order of ontological subject,
b. partitioning the given content to at least one partition having a predetermined type and order of ontological subjects
c. extracting textual semantic representation of at least one partition of the plurality of content and at least one partition of the given content,
d. finding at least one semantically related partition from said at least one partition of said plurality of contents to at least one partition of said given content, and
e. selecting the at least one semantically related partition from said one or more partitions of said plurality of content as a generated representative of at least one partition of the given content.

37. The system of claim 36 wherein the said predefined relationship function is semantic similarity between a pair of partitions of one or more contents.

38. The system of claim 36, wherein the given content is accessed through network communications interfaces.

39. The system of method 38, wherein the given content is provided by a client wherein the given content is one or more of contents of textual, aural, or visuals and wherein the data correspond to the given content is sent to the said system of generating content by electronic devices through at least one of a wired or wireless communication interfaces.

40. The system of 39, wherein said electronic devices are used in a wireless communication network environment.

41. The system of claim 36 further comprising:
a. a content database storing advertisement contents, and
b. selecting semantically related advertisement from the content database with said representative content and associating the related advertisement with the representative content in a predetermined format.

42. The system of claim 39, wherein the client further is provided with an option to do one or more of the followings:
a. store the generated content for the given content in the at least one storage medium of the system,
b. retrieve the generated content from the system,
c. forward or asking the system to send the generated content to a desired electronic address or website, and
d. broadcasting or publishing the generated content in a broadcasting or publishing shop for viewing by others.

43. The system of 39, wherein the system make the generated content available to users that have access to the system.

44. The system of claim 39, wherein the given content is a short message content having a predetermined maximum data storage space and the generated content is also a short message content having another predetermined maximum data storage space.

45. The system of claim 44, wherein the client is chatter and the given content is the input from said chatter wherein the generated content is in response of the chatter's input having predefined semantic relationship function with the chatter's input.

46. The system of claim 45 wherein the predetermined semantic relationship function is defined as measure of contextual similarity between at least one partition of the given input and at least one partition of the generated content.

47. The system of claim 36, wherein the computer or communication network is the internet.
